(19) United States
(12) Patent Application Publication
(10) Pub. No.: US 2007/0168696 A1
(43) Pub. Date: Jul. 19, 2007

(54) System for inventing computer systems and alerting users of faults

(75) Inventors: Lenny Ridel, Hod Hasharon (IL); Shlomo Lahav, Ramat Gan (IL); Miki Rubinshtein, Tel Aviv (IL); Boris Freydin, Rehovot (IL); Eden Shochat, Herzelia (IL); Orit Kislev Kapon, Kiryat-Ono (IL); Sergei Edelstein, Herzlia (IL)

Correspondence Address: GOODWIN PROCTER L.L.P, 599 LEXINGTON AVE., NEW YORK, NY, 10022, US

(73) Assignee: Aternity Information Systems, Ltd., Hod Hasharon (IL)

(21) Appl. No.: 11/588,537

(22) Filed: Oct. 26, 2006

Related U.S. Application Data
(63) Continuation-in-part of application No. 11/316,452, filed on Dec. 22, 2005.
(60) Provisional application No. 60/737,036, filed on Nov. 15, 2005.

(51) Int. Cl. G06F 11/00

(52) U.S. Cl. 714/4

(57) ABSTRACT

A first embodiment of the system and method of this invention is disclosed in a distributed computer system. The system is monitored by detecting activity signatures of individually identifiable network components, programs and/or PCs by sensing operations (keystrokes on a keyboard or mouse clicks) and/or codes embedded in data streams in the system. The activity signatures can be defined by result-specific character sets and are generated or provided for identifying the various activities of the system. After the activity signatures are generated, select information about select baselined attributes of activities detected by their activity signatures are measured and compiled in a database, and monitoring profiles (MPs) for the baselined attributes of activities are generated. The MPs are defined by a group of identifying attribute values of end-points so abnormal behavior of end-points/components can later be detected. For example, a disconnected server associated with a group of terminals can be detected.

### CROSS-REFERENCE TO PENDING PATENT APPLICATIONS

This application claims priority to and is a continuation-in-part of co-pending U.S. Ser. No. 11/316,452, filed Dec. 22, 2005, which is based on and claims the benefit of the filing date of U.S. provisional application Ser. No. 60/737,036, filed on Nov. 15, 2005, and entitled “System for Inventing Computer Systems and Alerting Users of Faults.” Both the nonprovisional application, Ser. No. 11/316,452, and the provisional application, Ser. No. 60/737,036, are incorporated herein in their entireties by references thereto.

### FIELD OF THE INVENTION

This invention relates to the field of monitoring and alerting users of monitored faults and/or correcting monitored faults of computer systems and particularly to the monitoring and alerting users of monitored faults and/or correcting monitored faults of distributed computer systems.

### BACKGROUND OF THE INVENTION

Computer systems exist, see FIG. 1, which include a plurality LANs 50 located at diverse geographic locations, such as 10, 20, 30 and 40, interconnected by a WAN 60 such as the internet. The system may also include one or more servers, databases and/or message queues and/or other network components associated with the WAN 60 or one of the LANs 50. A plurality of terminals or end points, such as C11 to C14 at location 10, C21 and C22 at location 20 and C31 at location 30, can be connected to one or more of the LANs 50 or directly to the WAN 60. Each end point can be a PC and may have a plurality of attributes and run a plurality of programs or applications. Each PC often interacts over the WAN 60 or LAN 50 with network components or other PCs. An application often performs more than one activity. For example, the program Outlook can send and receive e-mails, add or remove an appointment from a calendar and other activities. In turn each activity is usually constructed from a plurality of operations such as key strokes and mouse clicks, each of which generates one or more opcodes representing operations.

Computer systems and components thereof have many attributes. Some of the attributes are identifying attributes (e.g. identification of logged-in user, LAN subnet where it resides, timestamp of an activity, keyboard and mouse interactions, operating system on a server or PC or the PC or component itself.) Some of the attributes are baselined attributes (e.g. latency of an activity of the system.) FIG. 2 shows, in schematic form, PCs at a single location grouped according to certain identifying attributes. For example, all of the PCs in the left box operate off of DNS server DNS-1 while all of the PCs in the right hand box operate off of DNS server DNS-2. The PCs are also identified according to department of the logged in user such as sales or engineering. PCs also have backend identifying attributes such as the Database that particular PC's operation relies on.

Presently monitoring systems exist which monitor network components and applications running thereon either by using scripts to emulate a user or by having an agent associated with the network component that can be queried either periodically or as needed to see if the network component or application is functioning properly. These systems are usually at a shared data center at a location such as 40, see FIG. 1, and are preprogrammed. Of course the shared data center can be at any location, even locations 10, 20 or 30.

### BRIEF DESCRIPTION OF THE INVENTION

In a first embodiment of the system and method of this invention, a distributed computer system is monitored by detecting activity signatures of individually identifiable network components, programs and/or PCs by sensing operations (keystrokes on a keyboard or mouse clicks) and/or codes embedded in data streams in the system.

To initialize the system the activity signatures are generated for identifying the various activities of the system. Some of the activity signatures are generated while the system operates by sensing patterns of operations in the data streams. Some of the activity signatures are precompiled in the system, such as those relating to the basic system components that make up the system configuration (e.g. Lotus Notes and/or Outlook's MAPI over MSRPC) or are standard in computer systems such as commonly used protocols (e.g. DNS, DHCP). Other activity signatures can be defined by a user of the system, such as the start/finish indications for a given activity. Still other activity signatures are generated from the data streams themselves.

The activity signatures can also be generated by first defining a set of characters, each of which includes a result-specific operation verb. The activity signature can then be defined by a sequence of characters.

After the activity signatures are generated they are stored in a database 41, see FIG. 3, and used to further initialize the system for monitoring purposes. The system is run and select information about select baselined attributes of activities detected by their activity signatures are measured and compiled in the database 41. The signatures for measuring can relate to the activity signature for detection but may be longer or a shorter subset. As the information is being measured and compiled the system also generates monitoring profiles (MPs) for the baselined attributes of activities. The MPs are defined by a specific group of identifying attribute values of end points and/or system components so abnormal behavior of one or more end points and/or system components can later be detected. The identifying attribute values are also stored in the database 41 in relation to each end point and system component. Thus, each selected MP includes a combination of identifying attribute values (e.g.: time-of-day, subnet location and/or operating system) that can be used when examining end-points to decide whether the end point is part of that MP or not. Certain identifying attributes, such as departments can be imported from central organizational repositories like Directory servers see FIG. 3, 413, and assigned to specific end-point through other identifying attributes (e.g.: id of logged in user).

The system and method also provide for generating a load function to determine the effect that the load or volume of usage of activities has on select baselined attributes of these activities. The select baselined activities can then be normalized by the load function, which can be a function of response time, to remove the effect of load on one or more monitoring profiles. The load function can also be stored and/or visualized for assisting in capacity planning.

The system compiles baseline or critical values for select baselined attributes of MP's of the system in the database 41. Other baselines can be manually entered into the system such as when a monitoring organization agrees to help the system's users maintain at least a predetermined value for one or more combinations of attributes or MPs. In operation, the system monitors select MPs of the system, such as latency for sending an e-mail by users of Outlook for particular end points or components, against its baseline.

By properly analyzing deviating end points or components of the system one can determine what is causing a problem or who is affected by a problem based on which identifying attributes are common to the deviating end points or components. The first step in either determination is to form groups of deviating end points and/or components.

In particular, one or more terminals or end-points can be grouped into monitoring profiles for at least one of the select baselined attributes of a select activity which are in common. A deviation of the select baselined activities in magnitude and/or severity from the monitoring profiles of the group can generate an alert identifying a problem associated with the group of end-points or terminals. Such grouping of end-points with common select baselined attributes advantageously minimizes the occurrence of false positives.

If there is a problem identified, the system can either alert a user or the user's help organization or in some systems manually or automatically initiate corrective action. The problem can be classified into N levels of groups and sub-groups to identify appropriate resources for initiating such corrective action. In addition, user-provided system performance information can be provided in response to problem alerts to generate new sensitivity information. This new information can be used by the system to auto-tune the system sensitivity to the user's preferences.

In addition, common identifying attributes of terminals or end-points that deviate from the monitoring profiles can be correlated to determine the source or symptom of a problem. For example, for detecting a disconnect of a common network server, the common identifying attribute can be a common dynamic network server associated with a plurality of terminals. The select baselined attributes then include count attributes representing numbers of failed attempts to complete the select activities which are associated with an application program running on the common dynamic network server.

In a preferred embodiment of the system agents 80 are installed in some or all of the end points and/or components of the system for sensing and collecting that end points and/or components operations, see FIG. 3. Pluralities of agents 80 communicate with End Point Managers 101, 201 and 301 (hereinafter “EPM's”) over their associated LAN 50. The EPM's communicate with a Management Server 410 which in turn works with one or more Analytic Servers 411 and 412.

### DESCRIPTION OF THE DRAWINGS

The details of this invention will now be explained with reference to the following specification and drawings in which:

FIG. 1 is a system diagram of a multi office system of the prior art to the system of this invention.

FIG. 2 is a system diagram of a single office on the multi office system of FIG. 1.

FIG. 3 is a system diagram of a multi office system of the system of this invention.

FIG. 4A is a chart showing how operations are combined into activities and how attributes of the activity are measured.

FIG. 4B is a schematic representation of a load-response curve showing generally the shape of a load function that may be generated

FIGS. 5A-C show a series of histograms which are used in defining MPs for a system of this invention.

FIG. 5D shows a modified histogram corresponding to FIG. 5D, which includes an approximation of the distribution of counts within each bin.

FIG. 6 shows an activity diagram of certain activities.

FIG. 7 is a schematic representation of a problem-detection plot: a user-driven auto-tuning system sensitivity tool, which includes a plot of an attribute (response time) as a function of time above a plot of the corresponding volume of activity, with user-input capability for auto-tuning system sensitivity.

### DETAILED DESCRIPTION OF THE INVENTION

The aspects, features and advantages of the present invention will become better understood with regard to the following description with reference to the accompanying drawing(s). What follows are preferred embodiments of the present invention. It should be apparent to those skilled in the art that these embodiments are illustrative only and not limiting, having been presented by way of example only. All the features disclosed in this description may be replaced by alternative features serving the same purpose, and equivalents or similar purpose, unless expressly stated otherwise. Therefore, numerous other embodiments of the modifications thereof are contemplated as falling within the scope of the present invention as defined herein and equivalents thereto.

### Description of the Deployed System

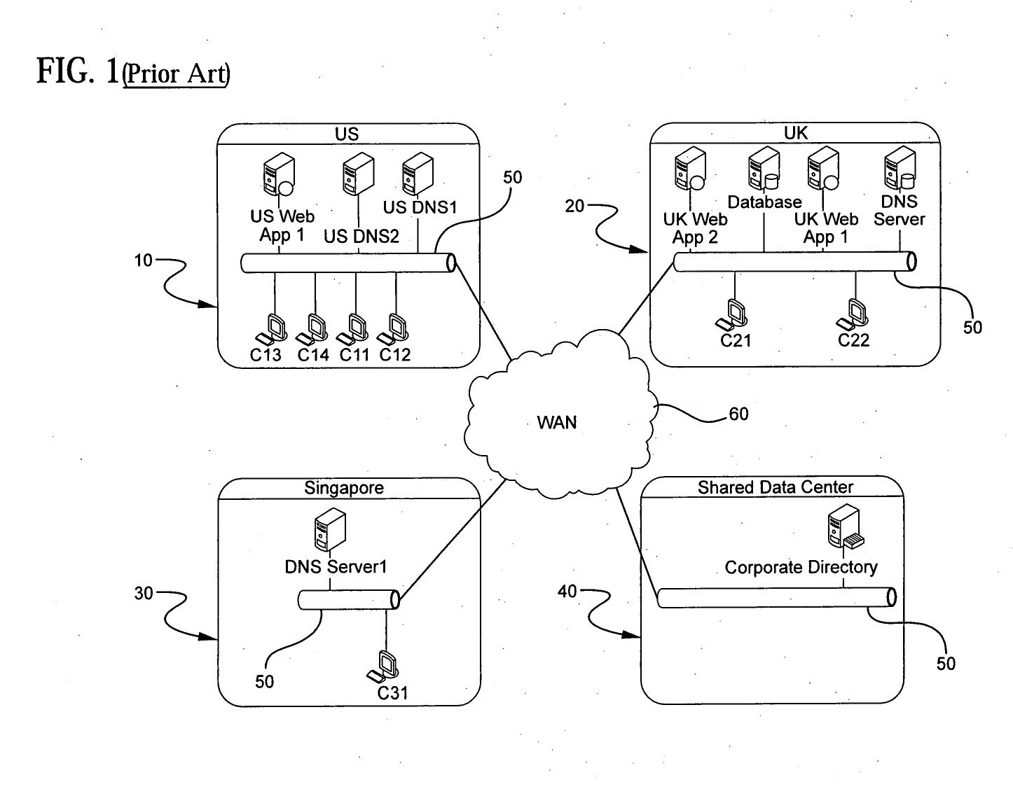

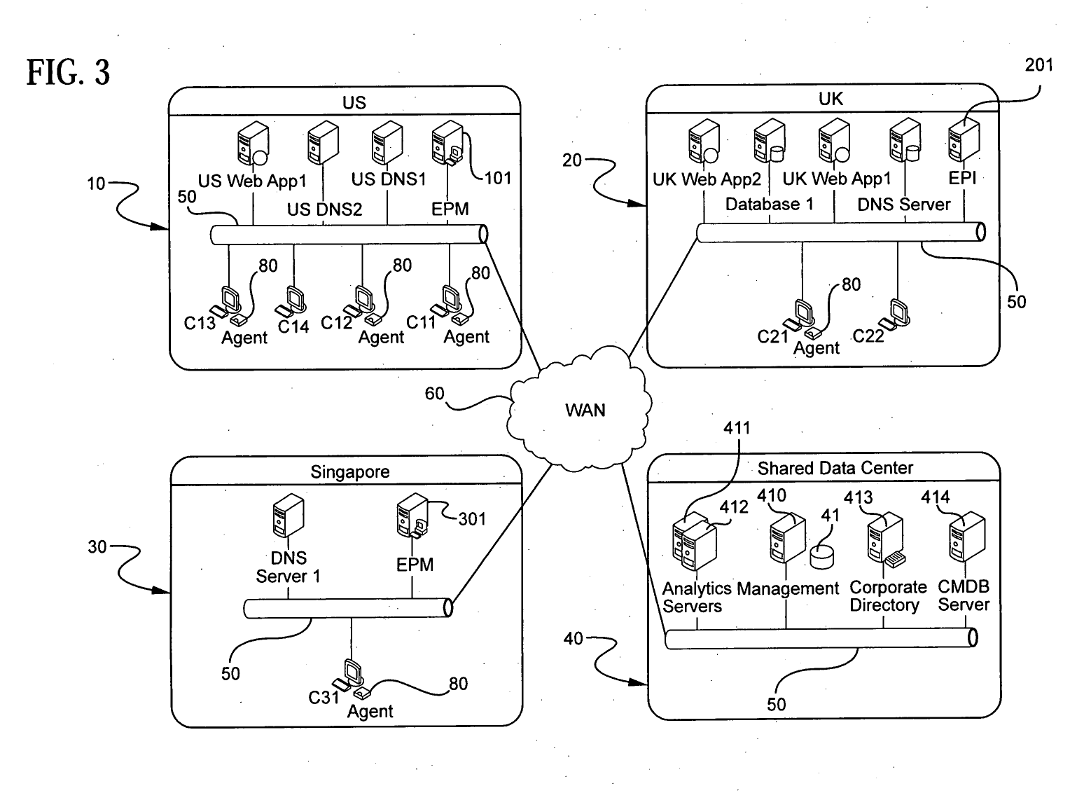

Referring now to FIG. 3, we see that the system of this invention includes four types of software modules not present in the prior art system of FIG. 1. These modules are 1) The Agents 80, charged with information collection, 2) the End-Point Managers (EPMs) 101, 201 and 301, charged with aggregation of information from a plurality of Agents 80 on a specific LAN 50, 3) the Management server 410, which includes a database 41, charged with managing the database 41, exposing a graphical user interface to an operator and workload coordination, and 4) Analytics servers 411 and 412, that generate the MPs, perform the base lining, deviation detection and classification. As new analytic servers are added, the Management server 410 automatically distributes work to these servers.

All Agents 80 installed on the end-points and/or components in their respective location communicate with the local End-Point Manager (EPM) 101, 102 or 301 over their respective LAN 50. EPMs 101, 201 and 301 communicate with the main system over the slower and more expensive WAN 60 and can be used to reduce the amount of communication traffic using different data aggregation and compression methods, for example by performing data aggregation into histograms [alternatively, the histogram generation can also done on the analytic servers]. Histograms serve as a condensed data form that describes the commonality of a certain metric over time. Histograms are used by the system in generating normal behavior baselines as well as performing deviation detection.

Each protocol running on the system has its own means for identifying the applications that are using that protocol. Each supported protocol (transactional protocols like HTTP, streaming protocols like Citrix, request-response protocols like Outlook's MailAPI, others) enumerates a list of applications detected by the Agents 80 to the system console on the Management server 410. This is stored in a persistent manner, allowing for the configuration of Agents 80 later on in the process and after a system re-start.

The Agents 80 monitor (measure and/or collect) the attribute values for end points, and components. For Outlook (the application) the Agent 80 monitors the latency of (1) sending e-mail (an activity) and (2) receiving e-mail (an activity). The latency and other attributes of each of the activities are the baselined attributes. Monitored attributes can include both identifiable attributes and baselined attributes such as: OS parameters, such as version, processes running; system parameters such as installed RAM and available RAM; application parameters such as response time for activities of applications.

The Agent 80 can send to the EPMs: 101, 201 and/or 301: 1) any measurement it makes (high communication overhead, low latency); 2) queue measurements and send at pre-determined intervals, potentially aggregating a few values together for transmission (low communication overhead, medium latency), or the combination; and/or 3) send any measurement that exceeds a pre-configured threshold immediately, but queue other measurements for later sending (low overhead, low latency).

The EPMs 101, 201 and 301 can aggregate such measurements into histograms. The EPMs 101, 201 and 301 generated histograms of monitored activity attributes in discovered applications are sent through a message subscription system (message queue) to several subscribing components in the system: 1) monitoring profile generation and 2) deviation detection, both on the Analytics servers 411 and 412.

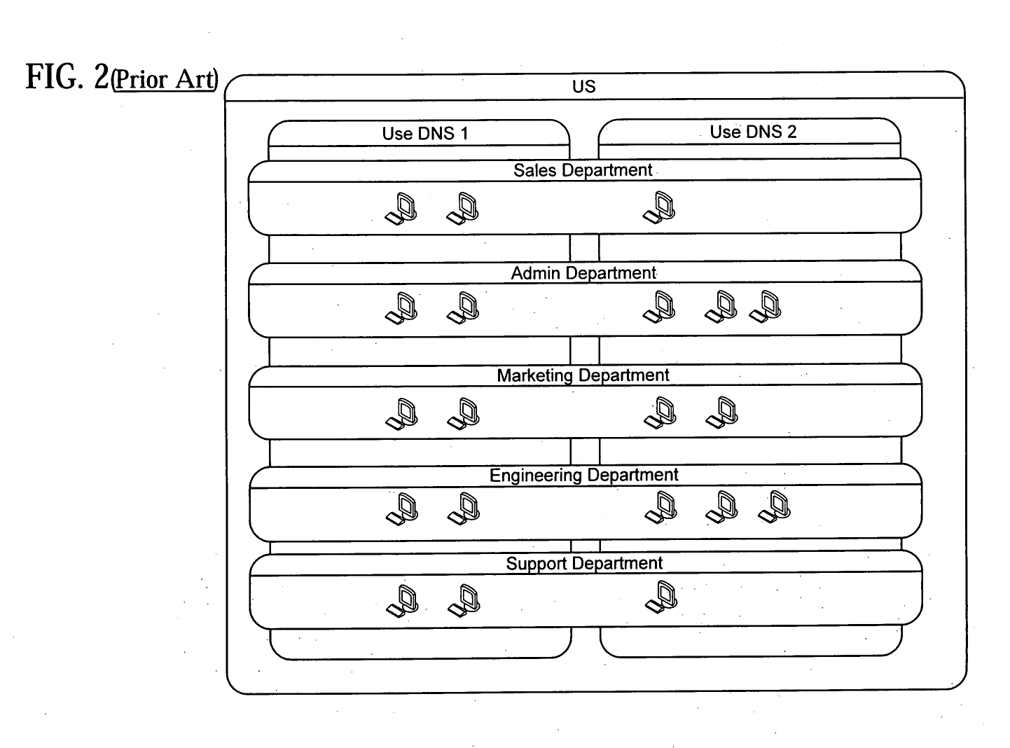

As seen in FIG. 3, the system could include a Directory server 413 to collect organizational grouping data such as shown in FIG. 2. Such integration allows later correlation of common deviating end points or components with organizational criteria, enabling output such as: “80% of the suffering population is in New York, and affects 20% of the Sales Department”.

Additional integration can be with a Configuration Management Database (CMDB) server 414, or other data sources where data about data center configuration items (CIs) and the relationships between them is available, to gather inter and intra application dependencies. Such integration allows for the generation of groups that are affected by back-end components. In a case where two applications both use a shared database, having the CMDB information can allow for later output such as: “The affected users represent the user population of two applications that both depend on a shared database server”.

As we see information collection is done through the Agents 80 installed on the end-points, but for certain limited systems could potentially be done through network sniffing, through the capture of network packets at the network level rather than the operation level as done with Agents 80.

The agent-based approach is a better implementation option because it allows augmenting the network usage data, such as the packets generated by an Outlook send request with system user interaction collection, such as the fact that the user clicked the mouse, or pressed enter on the keyboard. This is because many times knowing the user interacted with the user interface can indicate the start or end of the user activity. The agent exposes this data as additional identifying attributes. An agent-based approach is also more scalable and software is easier to distribute than hardware sniffers, as it can be downloadable through the network.

This agent-based approach can also be applied to determine when a server disconnect occurs, by monitoring network usage associated with an identifying attribute, e.g., a particular server. The value of the corresponding baselined attribute is then determined by the number of failed attempts to perform the activity, rather than as a latency or response time of the activity. For example, an agent, or client, attempts to connect to a server and fails. Multiple failed attempts are generated and collected by the associated end point manager. If only one client is monitored, such failed attempts could be the result of a malfunction of the client rather than a disconnect of the server. However, by associating the history of connection attempts of all clients associated with the same server, such false positives can be avoided.

An Agent approach also allows for far easier future support for the manipulation of operations. If a certain group of users does not adhere to baseline while a Service Level Agreement (SLA) the organization has requires it to conform to such baseline, an Agent-based approach could delay the sending of operations by another group in order to be able to satisfy the SLA. A network-based solution would have to queue the packets, requiring significant amounts of memory for an installation and also introducing unwarranted latency for queue processing.

System elements can communicate with each other through message oriented middleware (MOM) over any underlying communications channel. For example, through a publish/subscribe system, with underlying implementation through asynchronous queues. MOM, together with component based system design, allows for a highly scalable and redundant system with transparent co-locating of any service on any server, capable of monitoring thousands of end points.

### Activity Signature Generation

The system of this invention monitors a series of operations in applications, including, but not limited to, any combination of keystrokes on a keyboard, mouse clicks, and/or codes embedded in data streams, and combines these into activities. An activity's signature is a unique series of operations that signify that activity. Activities can be included in other activities. To accomplish this, the included activity would also be considered an operation (so it's included in the other activity). Activity signatures can also include identifying attributes to be able have a signature for a specific group of end points.

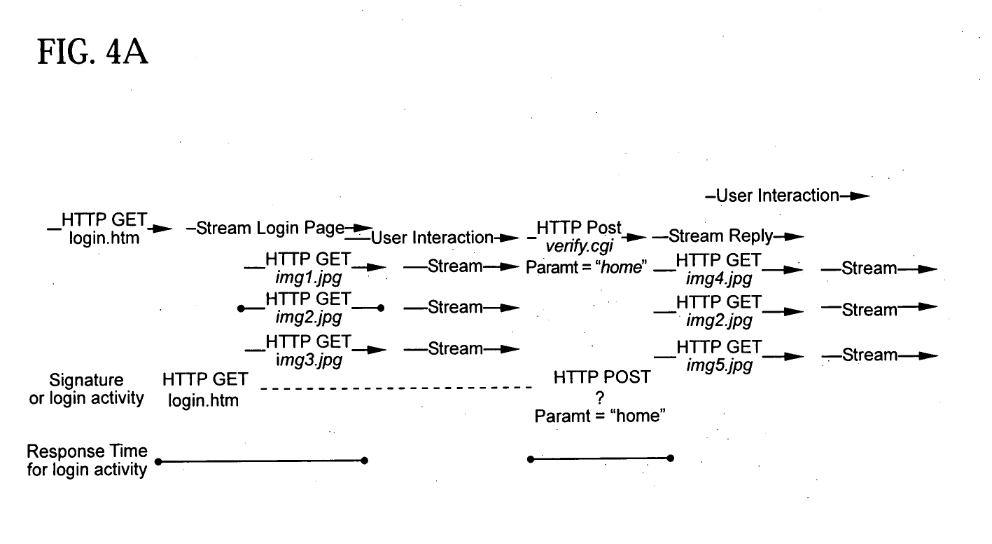

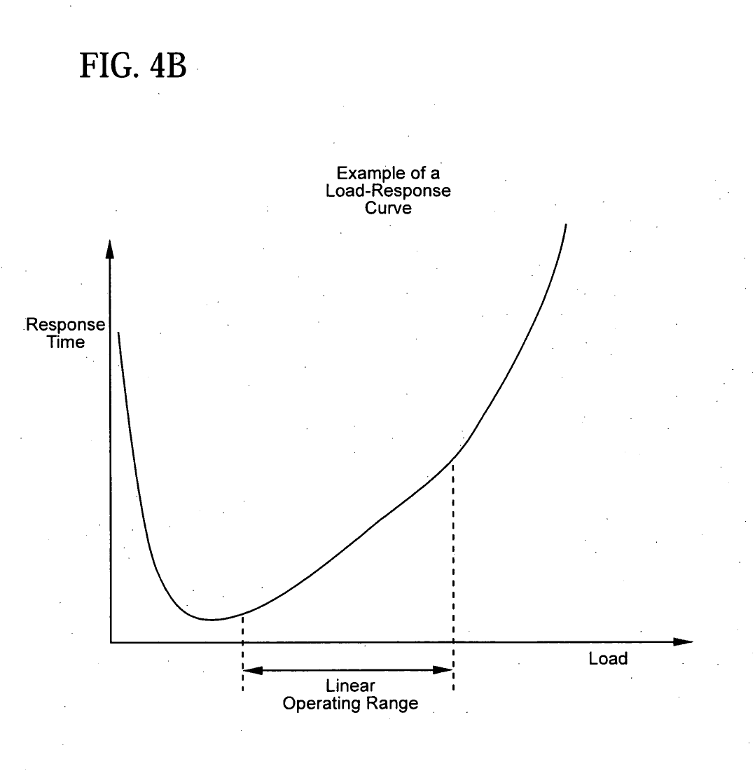

For example of an activity signature, as seen in FIG. 4A, a single login activity (as perceived by the user) in an HTTP-based application can be combined from a number of different operations. The login activity starts by executing a GET operation for the login.html file from the server. The browser then executes a GET operation for a series of embedded image files [possibly different every time]. While the requests are still fulfilling, the user is able to interact with the browser content. Once the user presses the submit button, the browser uses the POST operation with the first parameter set to the value “home”. The activity signature for the login activity would be an HTTP GET to the login page, followed by any number of additional GET operations and finalized by an HTTP POST with the first parameter set to “home”. Thus it is seen, in this instance, that the activity signature is defined by a starting operation and an ending operation with a number of operations in the middle that do not form a part of the signature.

In a preferred embodiment, activity signatures are defined not only by the type and sequence of commands, but also by specific types of data that are passed in order to reduce inherent deviation within measurements. Using the example provided above, a command or operation verb acts on a particular parameter, such as GET[parameter(s)] and POST[parameter(s)]. These particular commands are used to access a URL from a server; therefore, different parameters (URL's in this case) can return many different data types, including different MIME and file types (such as GIF, JPEG, text, and so on) and error codes. The response time for returning these different data types will markedly vary. Therefore, an activity signature which is based only on the operation verbs without consideration for the parameters acted on by the verbs will be difficult to accurately define. Because of the inherent variations that would occur during the data collection, such variations may erroneously result in the splitting of monitoring profiles, or cause the generated MP critical values to be highly insensitive, undesirably resulting in a high occurrence of false negatives.

To reduce variation of activity signatures for a specific application (and subsequently improve the accuracy of MPs generated), therefore, a character set is preferably generated which is based on more specific criteria at the operation level. In this embodiment, a sequence of defined characters, rather than a sequence of defined operation verbs comprises an activity signature. Each character includes a result-specific operation verb. For example, a character “A” can be defined as a request for a type of operation verb that results in particular response and MIME type, for example, an html. Character A, therefore, could include different verbs that do the same thing, like a POST and GET, so that GET and POST are evaluated together as a single character. Similarly, Login rules are well-known, and such requests can be grouped together. Character B could, for example, be any operation verb that returns a code 230, a message that verifies the action, such as a login attempt, was properly completed.

In this preferred embodiment, therefore, the activity signature which is defined for the login as shown on the left of FIG. 4A, which includes a GET (page html:\\ . . .) and ends with a POST that includes login information could be redefined in character sets. Using characters A and B as defined here, therefore, the activity signature for a login represented in FIG. 4A looks like: A[html//)]B[login].

By characterizing activity signatures in this protocol-specific manner, the deviation in generating activity signatures can be reduced three-fold.

Activity signatures can be generated and entered into the system in a number of different ways. Some of the activity signatures come preconfigured with the system. Examples of these are Outlook's MAPI over MSRPC and Note's NotesRPC.

Some of the signatures can be specified by the user, manually or through a recording mechanism that allows the user to perform the activity and have the system extract the operations from the recording which can then be used to form an activity signature.

Additional signatures can be generated by performing analysis of protocol traffic. This can be done through protocol analysis to generate an abstract (not protocol specific) sequence list of operation verbs. Next is the creation of activity signatures using statistical modeling techniques. For example, defining a dictionary of commonly used verb sequences and using this as the basis for a list of activities signatures definition. This is the preferred implementation, as it provides the greatest out-of-the-box value. The dictionary of commonly used verb sequences can be implemented through:

1. Collecting all opcodes performed by a subset of the end-points in the organization.

2. Grouping of opcodes that are executed in the same sequence. Grouping of similar sequences can be done through the use of clustering techniques (using timestamp deltas as the clustering criteria) or through the use of longest-sequence technique similar to LZ78, with wildcard support in order to allow for noise opcodes.

3. The above can be done first on a per end-point level to be able to reduce the complexity and then performing an additional step for uniting the result sets.

The analysis of protocol traffic to generate activity signatures can augment the user-specified recording mechanism as a way to support more complex protocols that have characteristics which are hard to record, such as loops (opcodes can be executed an arbitrary number of times in each communication) and noise opcodes (opcodes that can change between invocations of the same activity).

### Activity Signature Detection

After the activity signatures are generated they are used to further initialize the system and for monitoring purposes. The system is run and select information about select baselined attributes of activities are measured and compiled in the database 41. The signatures for measuring can relate to the activity's signature but may be longer or a shorter subset. Alternatively, different signatures altogether can be used for the detection of an activity and measuring of it.

Monitored operations are matched against the activity detection signatures, and once an appropriate one is found, the corresponding activity measurement signature is used to determine the value for the activity baselined attribute.

By not operating at the operation level but the activity level, the system is able to generate information about complete activities.

For example, response time of the login activity, see FIG. 4A, is measured by the time it takes from initiating the request to login.htm until finishing the download of it, and from POSTing the verify.cgi request until the first byte of reply streams in. The time the user fills in the form is not included. This provides an indication for the system time frame for the login.

Alternatively, even though the signature did not include the embedded image file, these could be measured as part of the total response time.

Signatures can also include identifying attributes to provide activity signatures for specific groups of end points such as time of day or department of the end user executing the operation.

### Generating and Implementing Load Functions

Load functions providing information on the effect that load or volume of an activity associated with a particular end point or groups of end points can have on any baselined attribute or attributes can be generated and used for capacity planning as well as to normalize data to remove the effect of load on system performance with respect to any performance metric or baselined attributes, including, but not limited to, response time/latency and count attributes. For example, when the attribute is response time, the load function (referred to herein, in this case, as the load/response function) approximates the response time of an operation or a number of operations as a function of the load.

Load information can come from different sources, such as agents, network monitors, or the server providing the operation and can be used in the evaluation of different applications. An example of load criteria is the number of “send e-mails” in Outlook at a particular time.

The shape of the load function will depend on the behavior of the particular application being monitored. For example, a typical load/response function that increases initially linearly followed by an exponential increase is characteristic of many applications. However, it has been found that the load-response curve for some applications can actually be a double-valued U-shaped function, as shown in FIG. 4B In this case, at very low loads, the response time is high. At some point as load increases, the response time increases linearly with load and then at some characteristic load value, the response time increases exponentially.

Visualization of the load-response curve, therefore, can be useful for capacity planning for the applications and services providing the service that is being monitored. Plots of the load-response curve are generated and stored for future use in capacity planning and general system monitoring.

An Alert can be generated when the load crosses a critical threshold value into an operating regime on the load function curve at which system performance will begin to quickly degrade. As explained above, there may be more than one such undesirable operating range, so that an alert can be triggered when the load is reduced below a minimum threshold load and/or when the load is increased beyond a maximum threshold load value. The system can then automatically reallocate system resources to redistribute the load and stay within a linear load-response regime. Such reallocation for real-time capacity management can include appropriate tuning of various application parameters, as well as implementing load balancing by rerouting traffic between different servers to optimize system performance parameters, for example, response time.

Once a load function has been obtained, the data can be normalized by this function to remove any variation in the monitoring profile that is due to load. A method of the present invention which implements the load function can include the following:

a) generating a plot of the monitored baselined attribute(s), such as response time/latency, count attributes, and so on, as a function of load for a determined group of measurements to generate a load function;

b) normalizing the measurement data to remove the effect of load using the load function; and

c) then passing the data to the MP engine to generate an MP.

An initial step can also be added which includes starting from a pre-configured load-response template as a best guess. Adjustments are then made to the initial starting point using correlation techniques or RMS fitting routines.

The group of measurements used to generate the load function can be extracted from the end-points comprising the existing monitoring profiles.

If the data is not normalized for load, the variations in the corresponding baselined attribute, for example, response time, caused by fluctuating loads could cause the monitoring profile (MP) to erroneously split to compensate, or cause the MP critical values to be invalid or imprecise, degrading the problem detection value. As described further in the following section, the MP splits populations according to homogeneous end points; i.e., populations are grouped so that each has similar characteristics. In a preferred mode, the data is normalized for load before the MP is generated, so that less MPs and more accurate MPs are generated.

The data can be similarly normalized for any other non-linear system parameter that can be monitored in order to avoid undesirably splitting the MP. For example, the data could be normalized for the current network load, if it is regarded by the operator as unneeded noise, for example, for application-only monitoring scenarios. By implementing this normalization, the ability of the system to identify problems and provide appropriate and timely alerts can be improved.

There are certain instances, however, when it is desirable to split the MP instead of normalizing the data. One example is when batch processing operations are run. As an example, if every day at 9 am it is known that a batch job is to be run, a different MP should be applied at that time. As another important example, while performing capacity planning runs, it would not be desirable to have the data automatically normalized. Instead, in this instance, load functions such as load/response curves can be visualized for use in capacity planning, alongside the non-normalized response time data.

In operation, it takes more time to generate the MPs than it does to generate the load functions (LF) as they require less data. For efficiency, therefore, generation of the LF(s) and normalization of the measurements by the LFs can be performed in parallel with generation of the MPs. It should also be noted that more than one type of load function can be generated simultaneously, based on different baselined attributes. The normalized measurements are then used in turn to provide a correction to the MPs, while the end-point populations of the MPs determine which measurements are evaluated together during LF generation, ad infinitum.

### Grouping End Points into Monitoring Profiles

The goal of generating monitoring profiles (MPs) is to have similarly identifiable groups of end points or components so we can detect abnormal behavior of a member or members of the group at a later time.

Each monitoring profile (MP) is defined by a combination of identifying attribute values that can be used when choosing end-points or components.

Each MP is used for evaluating a specific baselined attribute for deviation, so even though a single end-point usually belongs in a single monitoring profile for each baselined attribute at a given point in time, the same end-point can belong in multiple MPs for different baselined attributes.

Consider a system including a PC which performs an activity by accessing a Web Server which in turn accesses a database to return a response back to the PC through the Web Server. Further consider a plurality of PCs located in three different locations (the US, the UK and Singapore). In this system the Singapore PCs must use the US Web Server because there is none in Singapore and the Singapore and US PCs must use the UK database because there is none in either the US or Singapore.

In this situation the US users, accessing the local US Web App 1 server have slower performance than the UK users accessing the local UK Web App 1 server because the US server communicates with the UK-based Database. Singapore users have even lesser performance as they are accessing the US-based web server and the US server communicates with the UK-based Database.

On average, each of the users in US, UK and Singapore has similar performance to other users in the same country. Thus three different MPs can be used for similar activities being performed in different countries.

There could still be differences between PCs in one or more of these MPs, for example, because of different computer operating systems used by users, with some types offering better performance than others, so that further sub-grouping is desired. In this case, sub-groups may be formed within each group of users based on their operating systems (OS) (users in US with OS1, users in US with OS2, users in UK with OS1, and so forth).

The similarity allows the system to detect performance and availability deviations with low false positive and false negative rates, meaning with low rate of discovery of non-issues as issues and low rate of failing to discover issues.

In a specific implementation, the system represents the attribute values as dichotomous variables (“is subnet=10.1.2.3”, “is hour_in_day=5,6,7”) and performs model learning technique, for example decision tree, logistic regression or other clustering algorithms to detect which of the variables has the strongest influence on generation of a group viable for deviation detection. The preferred implementation uses the decision tree algorithm approach.

The output of the process is a list of attributes and values that when used to generate list of conforming end-points generates a list that is suitable for detection of deviation.

In a specific implementation, the system could consult with the user for attribute and specific attribute values that could represent a good predictor for homogenous behavior, and thus could be used by the system to define MPs. Such a user-driven predictor can be (in FIG. 3) Singapore, US and UK values of the Location attribute. The system could use these attribute/attribute values as priority predictor groups.

When the system finishes generating the MPs, the user could use the information to learn about his infrastructure behavior, and/or modify the MPs, providing their intimate knowledge of their infrastructure.

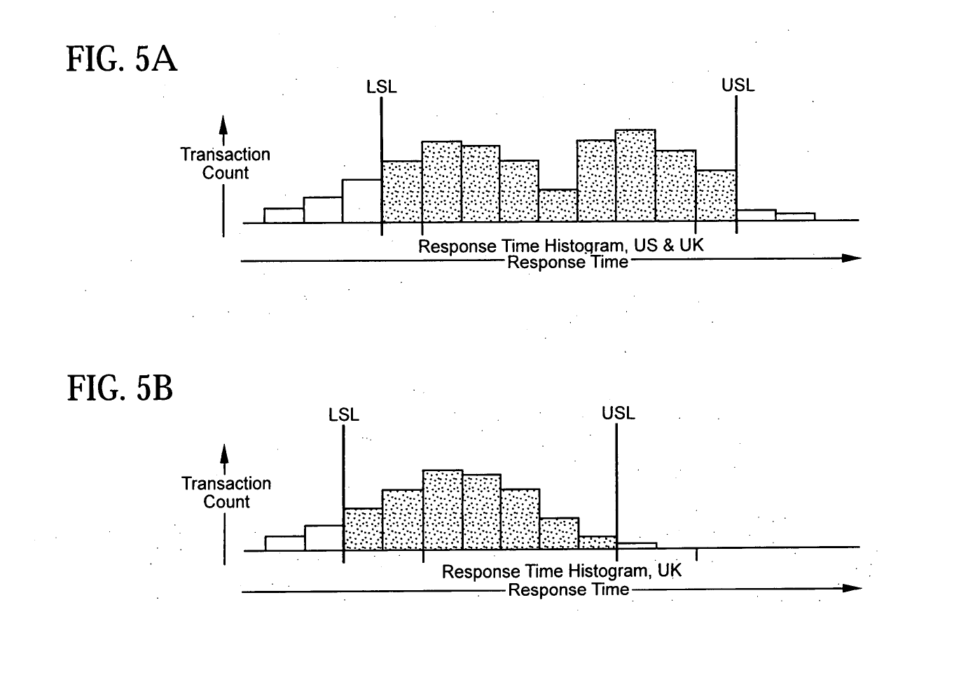

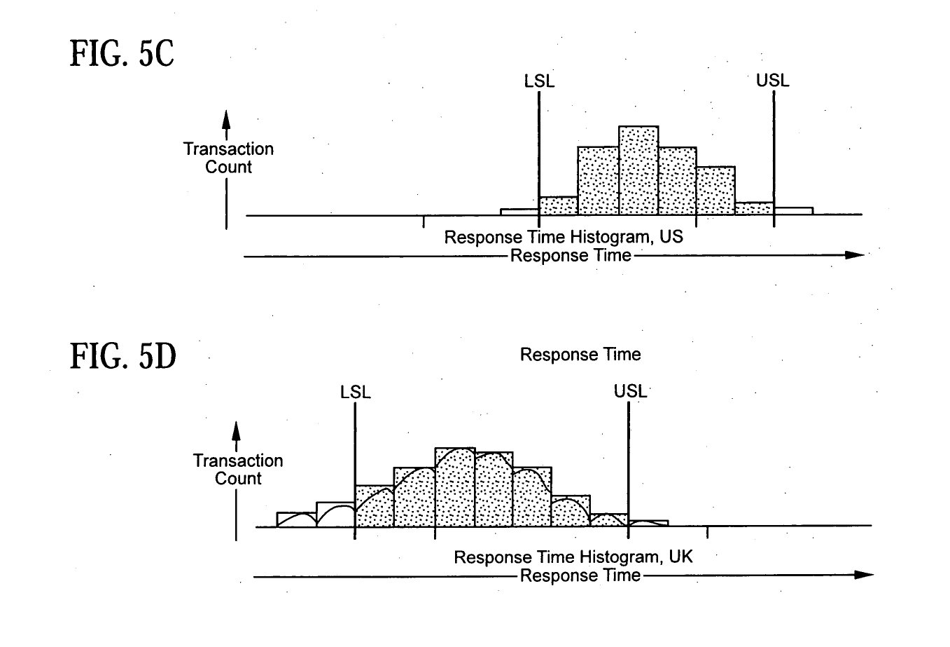

In FIG. 5A we see a histogram of an MP that has a baselined attribute with particular time values. In FIGS. 5B and 5C we see that either the system or an operator has split the MP into two MPs based on the two distinct peaks in FIG. 5A that represent two different identifiable attribute values such as different locations.

Another example of splitting MP can be when a cyclic event that slows down performance happens every Monday morning, and so initially when the MPs were generated, the event only happened once and didn't cause an MP to be generated. When this happens again, on the next Monday, the system or operator, could modify the MP and generate another MP, that each now includes (day_in_week=“Monday”, hour_in_day=“7,8,9”) and so represents a stronger potential detection ability.

If the user has specific obligations, such as Service Level Agreements (SLAs), the user could require a specific constraint according to the specific attribute value. Such SLAs could be: users in the UK location should have different performance obligation (99% of requests must finish within 2 seconds) than the US (99.9% of requests must finish within 1 second). Other possibility could be through another attribute, such as departmental grouping: users within Sales should have some form of a faster response than Administration.

### Baseline Generation

During the generation of the monitoring profile (MP) and depending on the sensitivity settings and types of problems a user may wish to detect, the system generates critical or baseline values used by the detection system for each MP. For example, if an MP is generated to monitor the latency or response time of an activity, the threshold or critical value that will trigger an alert will correspond to a time delta, e.g., 100 ms. For an MP that is generated to monitor a count attribute (e.g., number of failed attempts to perform an activity, such as an attempt to connect), the critical value is an aggregation of positive integers. Alternatively, the generation of critical values can be performed during system operation, depending on the current performance characteristics of the monitoring profile population and the sensitivity settings and types of problems user wish to detect.

In one implementation there could be a single maximum critical value threshold, while in another there could be multiple, e.g.: a minimum and maximum critical value, different critical values depending on number of deviating measurements, different critical values for different sensitivity settings. The advantage of this form of generating critical values instead of ranges of baselined attribute values is that we can take sensitivity into consideration, allowing the evaluation of both a severity of deviation, i.e., how big is the change or shift from the critical value for a specific sensitivity level, and a magnitude of deviation, i.e., how many of the end-points deviate from the critical value.

The critical values are used to configure the histogram binning, meaning the range values used for generating range counts (e.g.: 0 ms-100 ms: 110 ms, 100 ms-200 ms: 50 ms, etc) for the histograms.

Referring to FIG. 5D, in another embodiment, a function associated with each bin is also passed to the monitoring profile. FIG. 5D is a representation of FIG. 5B with the functions shown overlaid in each bin. The function provides more detail about the distribution of the counts within each bin, replacing the usual rectangular-shaped bins of known histogram with bins tailored to a more suitably characteristic shape. The function can be pre-packaged with the software or calculated from the measured data. Accordingly, the accuracy is improved in calculating various statistical parameters, including standard deviation, needed to detect performance deviations from the monitoring profile.

If the user has an SLA in place, he can set specific critical values to monitor and detect deviation from the SLA. The user can also provide guidance to the system to alert before such SLA is breached, allowing earlier remediation. The generated baselines can be used for deviation detection, as described below, as well as capacity planning of server capacity requirement vs. response time. We can use deviation points as indicators for less-than-required capacity.

### Deviation Detection

In operation the previously generated baselines are used to compare expected behavior with current one. In a specific implementation, hypothesis testing methods are used. In further specific implementations, the hypothesis testing methods would be chi-squared or z-test.

Using previously generated critical values for a given MP, the system generates histograms of end-point measurements for select baselined attributes. The system then may turn the histogram into a set of counts for each of the ranges configured by these baseline critical values. These counts are then translated to a current value representing the current MP behavior through the hypothesis testing method. If the baseline critical value is reached, there has been a deviation from the MP. If multiple critical values are evaluated, deviation detection will be performed for each of those critical values.

If the critical value is dependant on the number of measurements for a given period or depending on sensitivity and type of problems to detect, the system could configure multiple such range values for the generation of the bins.

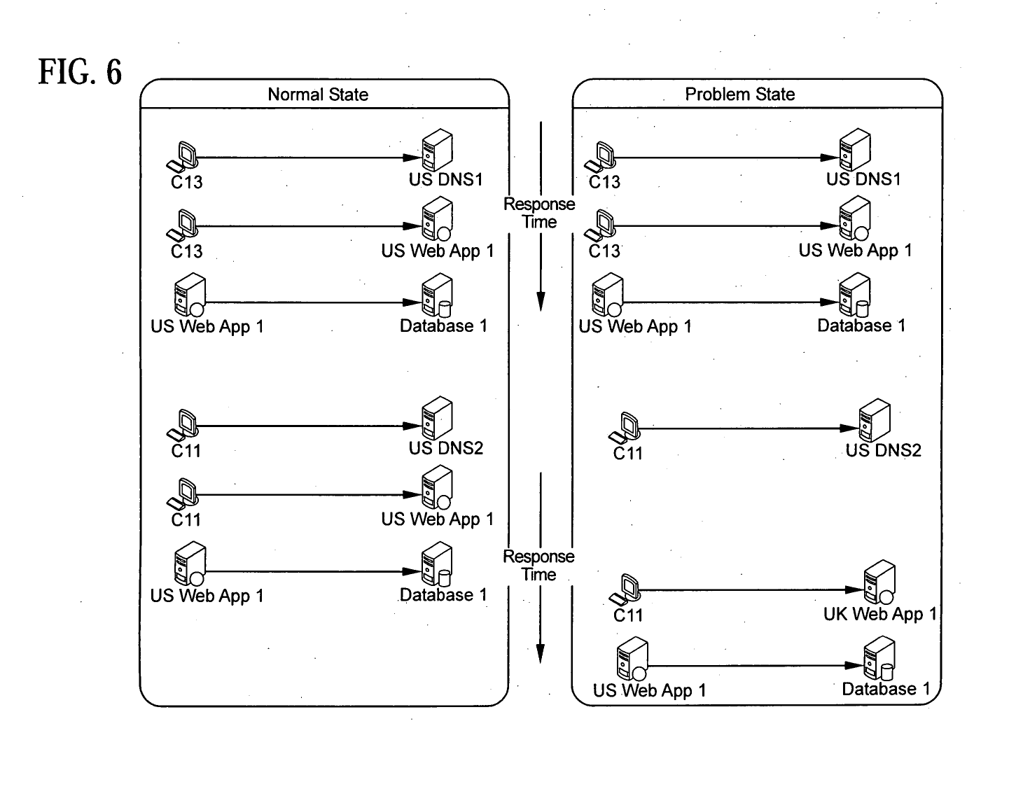

Referring now to FIG. 6, we see a flow diagram on the left side for the system of FIG. 3 properly operating for two separate activities and a flow diagram on the right side for the system of FIG. 3 properly operating for a first activity and not properly operating for a second activity. In the flow chart on the left side we see for the top flow that the PC C13 accesses US DNS 1 and returns a routing to the PC C13. The PC C13 then accesses US Web APP 1 which in turn access Database 1. As we can see from looking at the top flow for the right side the same flow is designated and there is no delay in operation on either side. When comparing the second flow on the two sides we see that the flow on the left side is normal but there is a gap, indicating a time delay, one the right side. By inspection we can tell that on the right side US DNS 2 returned the wrong information to the PC C11 and routed a message to UK Web App 1 instead of US Web App 1 causing a substantial delay. This time delay causes the activity represented by the second flow on the right to fall outside its MP and be detected.

In operation, to detect a problem, the system monitors select baseline attributes of activities of end points or components. For example, the latency for sending an e-mail by users of Outlook in a particular location can be monitored against its baseline. The system can either alert a user or the user's help organization if the baseline is not met at the then-current sensitivity settings, or in some systems manually or automatically initiate corrective action.

Certain deviations from the normal operating parameters can be seen as symptoms of problems. The multiple parameters indicating the magnitude and severity of these symptoms to be detected are collectively referred to as “the fault model.”

By grouping end points having similarly deviating attributes, the fault model of the present invention minimizes the occurrence of false-positive problem detection. For example, for Outlook, consider the attribute “latency” for the activity “send-mail.” The latency threshold must be met for a group of end-points with a given deviation severity for a period of time in order to indicate a problem with the application or network. If only one end-point was exhibiting this symptom, this may simply be an indication of an issue with a single computer runtime environment and not with the application. Similarly, if multiple end-points show only a minimal deviation, this can be a problem with a magnitude that the system administrators are not interested in.

As another example, by grouping count attributes, e.g., the number of failures associated with an activity such as “connect” to Outlook, the fault model can be adapted to the detection of an unavailable server. The system evaluates multiple end-points with non-zero unavailability counts. This count attribute is an indicator of availability of a server which serves as a baselined attribute for a group. If the unavailable count attribute for the group associated with the same identifying server passes a threshold as dynamically defined by the fault model, an alert is generated. This reliance on group behavior, rather than on a single measurement, minimizes the possibility of false positives being generated.

As described above, detection of a disconnect of a server is protected from false positives in the same manner that performance problem detection is. Indications of the availability of a server flow through the system in the same manner as performance availability of applications.

Once the symptoms of a problem are identified, the system can automatically initiates corrective action for each deviation or problem identified according to the classification of the problem, as discussed in the following section. The automatic corrective action can be implemented by first associating an identified problem with one of the system resources, components or applications running in the population defined by the end-points comprising the symptom, such as the operating system (OS), memory, hard disk, disk space, and so on. Each of these is associated with an appropriate service or support group equipped to handle the problem, e.g., hardware group, software group, network services, information technology, or business groups for application-specific problems. The system is configured to automatically alert and route the information required to correct the problem to the appropriate service or support group for initiating the appropriate corrective action.

The system can also store detection statistics for the then-current and otherwise sensitivity settings and generate reports and plots that represent how the sensitivity settings affect the alerts a user receives.

The sensitivity setting relates to the sensitivity parameters used to configure the fault model with which the system can detect a particular problem from a particular attribute, and is initially determined during the information collection stage that generates the histograms used to generate the monitoring profiles. Generally, the sensitivity determines the width of the histogram bins (see FIGS. 5A-C, for example) and is limited by the minimum detectable counts for a particular attribute. The sensitivity levels can also be tuned in response to feedback from the user, as discussed in “Providing Feedback to the System” below.

### Classification of Deviating End Points and/or Components

A symptom is defined as a deviation of a critical number of end-points or components within a single MP. A problem is defined as a combination of related symptoms. The combining of symptoms in this manner is called problem classification.

By properly analyzing deviating end points or components of the system one can determine what is causing a problem or who is affected by a problem based on which identifying attributes are common to the deviating end points or components. The first step in either determination is to form groups of deviating end points and/or components into symptoms.

A particular problem can be identified by correlating the common identifying attributes of the end points in the symptoms making up the problem. During the correlation process, the Analytics server process compares a group of affected end-points (comprising a symptom) to multiple groups of end-points that have specific identifying attribute values. The comparison process yields two numbers: positive correlation (How many of those in group A are members of group B) and negative correlation (How many of those in group B are NOT in group A) The importance of having both numbers is that B could be U (the “all” group) and so any group A would have very good positive correlation. The negative correlation in this case would be high, as many of those in group B aren't in group A. Searching for correlation results that combine multiple values can be computationally expensive and so a potential optimization is searching for a correlation that has a strong positive correlation metric, and adding additional criteria in order to reduce the negative correlation metric.

For example, one of the common identifying attributes can be DNS 2. This would indicate that this Domain Name Server (DNS 2) is a cause of the problem. As can be seen, knowing that many of those who are suffering are DNS 2 users can be very useful in determining the reason for the problem.

The same or other symptoms can provide context as to who's suffering, allowing the operator or system to decide on the priority of the problem depending on who's affected. For example one of the common identifying attributes can be department information. This information can be used to see which departments are effected and help can be provided in a predetermined order of priority.

For example, if some but not all end-points within the US office have a slow response time because of a DNS server problem, see FIG. 2, it's likely that multiple symptoms will be generated. The correlation process will indicate that the generated symptoms are comprised of end-points having the DNS-2 as a common identifying attribute. This will, help defining the problem comprised of the symptoms as related to DNS 2.

Simple solutions for problem classification are application-based (all symptoms for a given application are grouped together), and time-based (symptoms opened around the same time are grouped together) or a combination of the two. Alternatively, to be able to deal with problems in a way that is focused at resolving them, the system groups symptoms that have common correlation. This is the preferred implementation.

As additional symptoms are grouped together, and as additional end-points and/or components are assigned as suffering end-points within the symptom, the severity of the problem is calculated as a factor of the magnitude of the deviation and/or the number of end-points being affected.

In certain implementations, the severity could include additional information about the suffering end-points, such as their departments. One could also use financial metrics assigned to specific attribute values to accumulate the cost of the problem, and provide severity according to that.

When classifying, we search for a group of end-points, defined through a value (or values) of identifying attribute(s) that would have the best correlation metric to the end-points comprising an affected end-points of a problem. The goal of the classification process is to provide indications of commonality for the list of end points where a deviation was detected.

The system is able to generate all group data at all times, but can also optimize the process through prioritizing information collection for attributes deemed relevant over generally collected attributes.

Once the cause of the problem is identified, the problem can also be classified in accordance with an additional level of information required or task to be completed in response to the problem identification. For each task, the problem is classified as belonging to one of a number of groups, each of which can be further divided into sub-groups, and so on, providing any number N of levels of classification as desired, depending on the specificity of problem classification which is appropriate. For example, if the task at hand is to identify the appropriate personnel for initiating corrective action, the problem is classified into N levels of groups/sub-groups associated with identifying the appropriate resources for correcting the source of the problem. The first level can be divided generally into the type of problem identified, for example, whether the problem is associated with the operating system (OS), memory, hard disk, disk space, and so on. At the second level, the problem is further classified for corrective action as being associated with one of a number of divisions appropriate to handle the problem, e.g., hardware group, software group, network services, information technology, or business groups for application-specific problems. Each division can be further divided into various service groups, and so on.

If the desired task is identification of who is affected, in order to prioritize the order of repair by specified priority criteria, for example, then the problem can also be classified into identifying groups. Depending on the priority criteria, the identifying groups may classify the problem into N levels according to general physical location of those most affected, or the criticality of the work performed by those affected.

In every instance, the problem classification begins with associating the problem with a group associated with the source of the problem, the affected personnel or other means of grouping end-points. Further N levels of classification are defined in accordance with further action desired. This meta-classification of the source and effect of each problem identified can also be stored and statistics run and reports generated on a regular basis in order used to identify consistent trouble areas.

### Providing Feedback to the System

If the system detects a problem, the system operator (an IT operator, administrator or help desk representative) can instruct the system through the GUI-based console to either split the relevant MP in to two or more MPs, combine parts of the identifying attribute values of the MP to other MPs or not to do anything. If the symptom indicates a part of a problem nothing is done because the system is operating properly. If the symptom merely indicates, for example, end points at different locations, the MP will be split to accommodate these two or more normal situations. Alternatively, the user could change the sensitivity settings used by the deviation detection to a higher or lower threshold, depending on whether he would like more or less alerts. The system can provide the user with information related to previously stored detection statistics for the user suggested sensitivity setting.

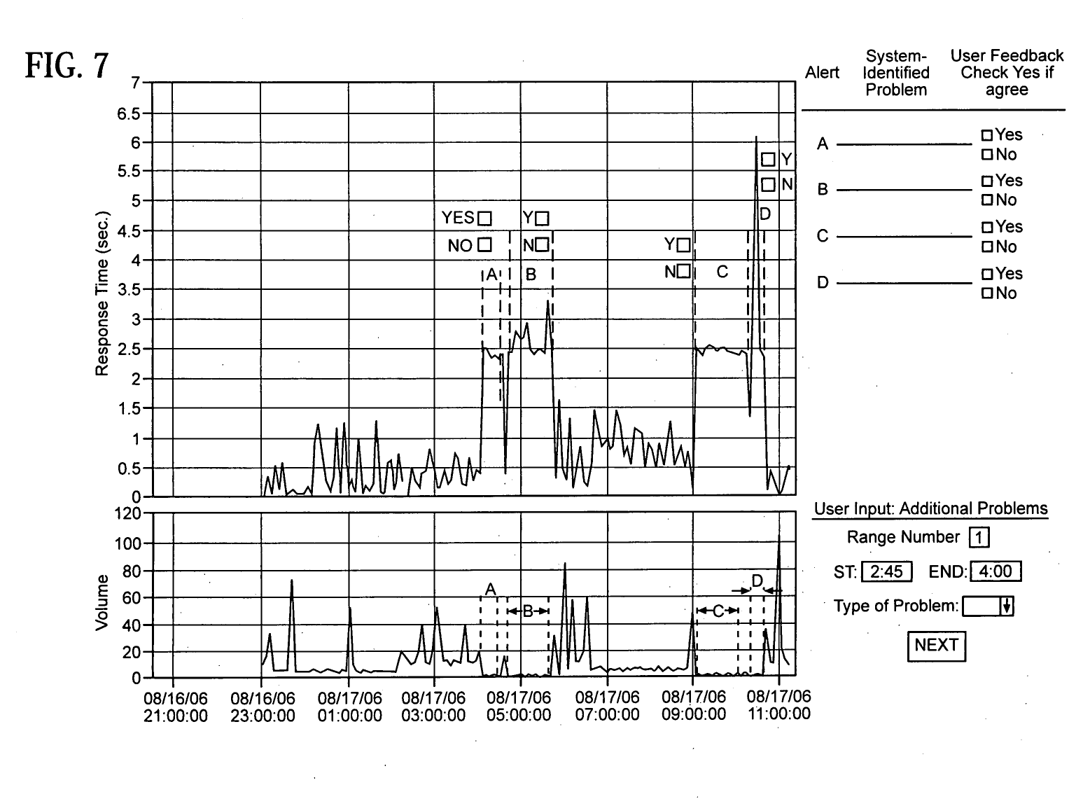

In particular, referring to FIG. 7, in one embodiment, the system sensitivity level can be auto-tuned in response to feedback from the user. FIG. 7 shows an example of an attribute (response time) plotted as a function of time for a particular activity alongside a time-coincident plot of some characteristic of the system end-points (in this case, load, or volume of activity) used to generate a particular monitoring profile or multiple profiles. Overlaid on the plot are problem identification alerts which indicate what problem was detected, and during what point in time. These plots can be generated for other attributes besides response time, and compared to other characteristics of system usage other than load.

The problem-detection plots are provided to the user, preferably in a Macromedia Flash, Java-based or other user-input capable format, so that the user can determine whether all of the alerts that are being generated are necessary, and whether the user perceived problems with the system that were not detected by the system. The user can then provide feedback, for example, by clicking on indicators overlaid on the plots to flag problem areas. As shown in the example of FIG. 7, this can be accomplished by simply clicking in a “Yes” or “No” box, located either on or next to the plot to flag the user's agreement or disagreement with the indicated problem. In addition, a text-input box and/or a click-and-drag method can be supplied for the user to indicate portions on the plot where a problem was perceived by the user, but which does not appear to have been picked up by the system. The nature of the problem perceived during that time can be input to the system by the user, for example, through a drop-down menu box provided with different categories of possible problems. Any number of ranges may be input to indicate different problems experienced by the user. In the example shown, a toggle “NEXT” can be clicked to input a range and associated problem and allow a new range/problem to be entered. In this way, the system and method of the present invention allows monitoring of the system performance in accordance with the user's experience and from the user's perspective.

The user feedback is then used by the system to auto-tune the detection sensitivity in order to align the user's experience with the system's problem detection results. In particular, in response to the user feedback, the system runs simulations to generate the same conditions indicated by the user. Sensitivity settings are altered and the simulations repeated until the same problems perceived by the user are also seen by the system. Any technique suitable for tuning parameters using simulations, as in adaptive learning methods, can be used to auto-tune the sensitivity settings in this way, including non-linear regression fitting methods.

### Generation of Reports

Unique performance data collected by the system includes actual application performance from the end user perspective. Unique problem data collected by the system includes actual affected end-points and their identifying attributes, such as the logged in end-user, problem magnitude and actual duration.

This information can then be used to generate reports about problem magnitude, who are the affected users, what is common to these affected and root-cause of the problem. This information can also be used to generate problem-related reports, including: most serious problems, repeat problems (problems closed by the IT personnel while not really closed), and so on.

Additional analysis of problem data in general with reports thereon, and specifically the commonality and root-cause analysis can indicate weak spots in the infrastructure. This is useful information for infrastructure planning. Additional analysis and generation of reports of application performance data and resulting baselines can be used for capacity planning.

Of course, one skilled in the art will recognize that any of the data input by the user and/or generated by the system can be used to generate a variety of logs and/or reports.

While this invention has been described with respect to particular embodiments thereof it should be understood that numerous variations thereof will be obvious to those of ordinary skill in the art in light thereof.

What is claimed is:

1. In a monitoring method for monitoring a distributed computer system; said distributed computer system including a plurality of LANs located at diverse geographic locations interconnected to each other; said distributed computer system also including one or more network components associated with one or more of said LANs; said distributed computer system also including a plurality of terminals connected to one or more of said LANs; one or more of said terminals, LANs and/or network components having a plurality of identifying attributes and/or baselined attributes; a plurality of said terminals and/or network components running a plurality of application programs; one or more of said application programs performing more than one activity; wherein each activity is constructed from a plurality of operations which generate one or more opcodes representing said operations; said monitoring method including the steps of:
generating activity signatures for select activities of identifiable network components, programs and/or terminals;
generating one or more select information values for select baselined attributes of said activities; and
generating one or more monitoring profiles for at least one or more of said select baselined attributes of one of said select activities.

2. The method as defined in claim 1 in which said step of generating select information values for select baselined attributes of said activities uses said activity signatures to generate said select information values.

3. The method as defined in claim 1 in which said step of generating one or more monitoring profiles uses said select information values therefore.

4. The method as defined in claim 3 in which said step of generating select information values for select baselined attributes of said activities uses said activity signatures to generate said select information values.

5. The method as defined in claim 1 also including the steps of:
identifying network components, programs and/or terminals which deviate from a monitoring profile associated therewith to identify one or more problems; and
providing an indication or record of said one or more problems.

6. The method as defined in claim 1 in which said generating of said activity signatures for identifiable network components, programs and/or terminals includes sensing operations and/or codes.

7. The method as defined in claim 1 in which some of said activity signatures for identifiable network components, programs and/or terminals, information values for select baselined attributes of said activities and/or monitoring profiles for at least one or more of said select baselined attributes of one of said select activities includes precompiled ones.

8. The method as defined in claim 1 in which some of said activity signatures for identifiable network components, programs and/or terminals, information values for select baselined attributes of said activities and/or monitoring profiles for at least one or more of said select baselined attributes of one of said select activities includes ones provided by a user of said monitoring system.

9. The method as defined in claim 8 in which some of said activity signatures for identifiable network components, programs and/or terminals include precompiled activity signatures.

10. The method as defined in claim 1 in which some of said activity signatures for identifiable network components, programs and/or terminals, information values for select baselined attributes of said activities and/or monitoring profiles for at least one or more of said select baselined attributes of one of said select activities includes precompiled activity signatures.

11. The method as defined in claim 5 in which said providing an indication of said one or more problems includes alerting a user of said one or more problems.

12. The method as defined in claim 5 in which said providing an indication of said one or more problems includes alerting a help desk of said one or more problems.

13. The method as defined in claim 5 in which said providing an indication of said one or more problems includes initiating corrective action.

14. The method as defined in claim 5 also including said step of grouping said network components, programs and/or terminals which deviate from a monitoring profile associated therewith into symptoms.

15. The method as defined in claim 14 also including said step of correlating said common identifying attributes of said network components, programs and/or terminals in said symptoms making up said problem.

16. The method as defined in claim 15 also including said step of problem classification by combining a defined set of said symptoms into a problem.

17. The method as defined in claim 16 in which said providing an indication of said one or more of said problems includes alerting a user of said one or more problems.

18. The method as defined in claim 16 in which said providing an indication of said one or more of said problems includes alerting a help desk of said deviating network component, program and/or terminal of said deviation.

19. The method as defined in claim 16 in which said providing an indication of said one or more of said problems includes initiating corrective action.

20. The method as defined in claim 5 in which the severity of said problem is calculated as a factor of the magnitude of the deviation of said monitoring profiles and/or the number of said network components, programs and/or terminals being affected.

21. The method as defined in claim 5 in which the severity of said problem is calculated as a factor of the department or persons that is affected.

22. The method as defined in claim 5 in which the severity of said problem is calculated as a factor of a financial metrics assigned to specific attribute values to accumulate the cost of said problem.

23. The method as defined in claim 20 in which the severity of said problem is also calculated as a factor of the department that is affected.

24. The method as defined in claim 23 in which the severity of said problem is also calculated as a factor of a financial metrics assigned to specific attribute values to accumulate the cost of said problem.

25. The method as defined in claim 1 in which said step of generating select information values for select baselined attributes of said activities generates a plurality of select information values for each of said select baselined attributes, the method further including monitoring said select baselined attributes with respect to said plurality of select information values to generate sensitivity information.

26. The method as defined in claim 25 also including said steps of:
identifying network components, programs and/or terminals which deviate from a monitoring profile associated therewith in accordance with one or more of said plurality of select information values to identify one or more problems; and providing an indication of said one or more problems.

27. The method as defined in claim 26 further including a user setting said one of said plurality of select information values using said sensitivity information.

28. In a monitoring system for monitoring a distributed computer system; said distributed computer system including a plurality of LANs located at diverse geographic locations interconnected to each other; said distributed computer system also including one or more network components associated with one or more of said LANs; said distributed computer system also including a plurality of terminals connected to one or more of said LANs; one or more of said terminals, LANs and/or network components having a plurality of identifying attributes and/or baselined attributes; a plurality of said terminals and/or network components run a plurality of application programs; one or more of said application programs performing more than one activity; wherein each activity is constructed from a plurality of operations which generate one or more opcodes representing said operations; said monitoring system including:
apparatus for generating activity signatures for select activities of identifiable network components, programs and/or terminals;
apparatus responsive to one or more of said activity signatures for generating one or more select information values for select baselined attributes of said select activities;
apparatus responsive to one or more of said select information values for generating one or more monitoring profiles for at least one or more of said select baselined attributes of one of said select activities.

29. The system as defined in claim 28 also including:
apparatus for identifying network components, programs and/or terminals which deviate from a monitoring profile associated therewith to identify one or more problems; and
apparatus for providing an indication of said one or more problems.

30. The system as defined in claim 29 also including:
apparatus for grouping said network components, programs and/or terminals which deviate from a monitoring profile associated therewith into symptoms.

31. The system as defined in claim 30 also including:
apparatus for correlating said common identifying attributes of said network components, programs and/or terminals in said symptoms making up said problem.

32. The method as defined in claim 1 in which two activity signatures are generated for some or more baselined attributes, one for detecting the baselined attribute and one for measuring the baselined attribute.

33. The method as defined in claim 1, said plurality of operations including at least one of a keystroke, a mouse click, and a code embedded in a data stream.

34. The method as defined in claim 1, further including grouping one or more of said terminals into one of said generated monitoring profiles for at least one of said select baselined attributes of one of said select activities.

35. The method as defined in claim 34, further including detecting a deviation of said select baselined attributes from said generated monitoring profiles of said group formed from said grouping step, wherein said deviation generates an alert identifying a problem associated with said group.

36. The method as defined in claim 5, said identifying step further including identifying and grouping one or more of said terminals having said select baselined attributes in common, each of which deviate from said monitoring profile by at least one of a magnitude and a severity.

37. The method as defined in claim 36, wherein said providing step includes providing an alert in response to said deviation of select baselined attributes of the group of one or more of said terminals defined in said grouping step exceeding said at least one of said magnitude and said severity, whereby said method minimizes the occurrence of false positives of said one or more problems.

38. The method as defined in claim 15, wherein said common identifying attributes of said network components, programs and/or terminals include a common dynamic network server associated with a plurality of said terminals, and wherein said select baselined attributes include count attributes representing numbers of failed attempts to complete said select activities, said select activities being associated with an application program running on said common dynamic network server.

39. The method as defined in claim 38, wherein said problem being monitored by said one or more monitoring profiles includes a disconnect of said common dynamic network server.

40. The system as defined in claim 29, wherein said network components, programs and/or terminals include clients and at least one dynamic network server associated therewith and wherein said one or more problems which said apparatus is adapted to identify includes a disconnect of said at least one dynamic network server.

41. The method as defined in claim 27, wherein said user setting step includes the steps of said user providing system performance information in response to said providing said indication of said one or more problems, said method further including adjusting said generated sensitivity information in response to said user-provided system performance information to generate new sensitivity information for providing said indication of said one or more problems.

42. The method as defined in claim 41, wherein said one of said plurality of select information values include threshold or critical values, wherein deviation of said select baselined attributes beyond said threshold or critical values triggers an alert to indicate said one or more problems said user wishes to detect.

43. The method as defined in claim 42, said method further including generating a problem-detection plot based on current-generated sensitivity information, wherein said user-provided system performance information is input via user interaction with said problem-detection plot.

44. The method as defined in claim 1, wherein said generating one or more monitoring profiles includes generating histograms of select baselined attribute values, said method further including providing critical values used to monitor deviation from said one or more monitoring profiles, said histograms including bins with associated functions to increase an accuracy of monitoring said deviation from said one or more monitoring profiles.

45. The method as defined in claim 5 further including automatically initiating corrective action for said one or more problems.

46. The method as defined in claim 5 in which said providing an indication or record of said one or more problems includes classifying said one or more problems into N levels of groups and sub-groups identifying appropriate resources for said automatically initiating corrective action for each of said one or more problems.

47. The method as defined in claim 1, said method further including generating a load function to determine the effect that load or volume of usage of said activities has on said select baselined attributes of said activities.

48. The method as defined in claim 47, said method further including normalizing said select baselined attributes by said load function to remove the effect of said load on said one or more monitoring profiles.

49. The method as defined in claim 48, wherein said select baselined attributes include response time, said normalizing step removing the effect of said load on said response time in generating said one or more monitoring profiles.

50. The method as defined in claim 49, said method further including at least one of storing and visualizing said load function for assisting in capacity planning.

51. The method as defined in claim 6, wherein said generating of said activity signatures further includes defining a character set, wherein each character includes a result-specific operation verb, said activity signature being defined by a sequence of said characters.
